(19) United States
(12) Patent Application Publication
(10) Pub. No.: US 2008/0189299 A1
(43) Pub. Date: Aug. 7, 2008

(54) METHOD AND APPARATUS FOR MANAGING DESCRIPTORS IN SYSTEM SPECIFICATIONS

(76) Inventors: Ulrich Karl Heinkel, Chemnitz (DE); Joachim Knaeblein, Erlangen (DE); Axel Schneider, Baiersdorf (DE)

Correspondence Address: PATTERSON & SHERIDAN, LLP/;LUCENT TECHNOLOGIES, INC, 595 SHREWSBURY AVENUE, SHREWSBURY, NJ, 07702, US

(21) Appl. No.: 11/670,492

(22) Filed: Feb. 2, 2007

(51) Int. Cl. G06F 17/30

(52) U.S. Cl. 707/100; 707/E17.005

(57) ABSTRACT

The invention includes a method and apparatus supporting system specification creation by providing descriptor management functions. A method according to one embodiment of the invention includes receiving a request for descriptor information maintained in a descriptor dictionary comprising a plurality of descriptor entries defining a respective plurality of descriptors, determining a context associated with the request for descriptor information, retrieving a subset of the descriptor entries of the descriptor dictionary according to the determined context, and inserting into a presentation data stream imagery associated with the subset of descriptor entries to enable selection of one or more of the descriptor entries for insertion of the corresponding descriptor within a worksheet.

### FIELD OF THE INVENTION

The invention relates to the field of system implementation processes and, more specifically, to creating requirements specifications.

### BACKGROUND OF THE INVENTION

A technical specification is often the basis for the implementation of a technical system. A technical specification may include one or more system requirements documents that define the technical system. The technical specifications typically define the technical system in terms of objects, such as registers, pins, and similar components. The technical specifications typically define such objects using short descriptors known as mnemonics. Depending on the type and size of system being developed, hundreds or even thousands of different descriptors may be required to define objects of the technical system. Currently, technical specifications are typically created using word processing applications (such as Microsoft WORD, Adobe FRAMEMAKER, and other such applications), and, after being created, technical specifications may be managed using technical specification management systems (such as Telelogic DOORS and other such systems).

Disadvantageously, however, existing word processing applications and requirement management systems do not include support for descriptor management. Thus, with potentially thousands of descriptors being used in a technical specification, problems often associated with the use of descriptors (e.g., multiple definitions, misinterpretations, and other similar problems) become almost inevitable. These problems often introduce errors during the system development process, thereby resulting in reduced quality of the technical system. Furthermore, such problems are exacerbated when the technical specification is created by a work group because some members of the work group may not be aware of descriptors being used by other members of the work group, thereby resulting in inconsistent descriptor usage throughout the technical specification.

### SUMMARY OF THE INVENTION

Various deficiencies in the prior art are addressed through the invention of a method and apparatus supporting system specification creation by providing descriptor management functions. A method according to one embodiment of the invention includes receiving a request for descriptor information maintained in a descriptor dictionary comprising a plurality of descriptor entries defining a respective plurality of descriptors, determining a context associated with the request for descriptor information, retrieving a subset of the descriptor entries of the descriptor dictionary according to the determined context, and inserting into a presentation data stream imagery associated with the subset of descriptor entries to enable selection of one or more of the descriptor entries for insertion of the corresponding descriptor within a worksheet.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a general-purpose computer adapted to support descriptor management functions of the present invention;

FIG. 2 depicts a descriptor dictionary according to one embodiment of the present invention;

FIG. 3 depicts a method according to one embodiment of the present invention;

FIG. 4 depicts a method according to one embodiment of the present invention;

FIG. 5 depicts an exemplary graphical user interface displaying a system specification application including a specification worksheet and descriptor search results according to one embodiment of the present invention; and

FIG. 6 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention supports the system development process, which proceeds from system specification to system implementation. A system specification defines technical requirements that must be satisfied by the implemented system. A system specification typically serves as a starting point for the system development process. The system specification may evolve during the system development process as the technical details of the system specification are further defined (e.g., as system design documents and other documents are defined). The present invention supports the system specification creation process. Specifically, the present invention supports the system specification creation process by providing descriptor management functions in the form of a descriptor management tool for managing descriptors during the system specification creation process.

The present invention supports the system specification creation process by providing descriptor management functions. A descriptor is a device for specifying information in a reduced format. A descriptor may use one or more specific characters or string of characters to convey information. A descriptor may use one or more character positions to convey information, where each character position is associated with a different feature and the definition of a feature depends on the character inserted within the character position associated with that feature. For example, descriptors which may be managed according to the descriptor management functions of the present invention may include mnemonics, acronyms, identifiers, and the like, as well as various combinations thereof.

A mnemonic is a device for specifying information in a reduced format, using one or more character positions to convey information, where each character position is associated with a different feature and definition of each feature depends on the character inserted within the character position associated with that feature. For example, mnemonics may be used to define software functions (e.g., programs, routines, sub-routines, and the like), electronic components (e.g., registers, flip-flops, operational amplifiers, and the like), and the like, as well as various combinations thereof.

An acronym is a word formed from letters or groups of letters of words in a set phrase or series of words. An identifier may include any character or string of characters that identifies an element, object, feature, function, and the like, as well as various combinations thereof. For example, an identifier may be a reference number identifying an element depicted in one or more figures of a specification, referencing an item in one or more tables of a specification, referencing an explanation in one or more separate parts of the specification, and the like, as well as various combinations thereof. In other words, a identifier is a value adapted for more easily identifying a particular element, object, feature, function and the like, as well as various combinations thereof.

The present invention, by providing descriptor management functions in a specification environment, provides several advantages over existing word processing applications. For example, the descriptor management functions of the present invention, including descriptor creation, searching, filtering, displaying, browsing, insertion, and like descriptor management functions, reduce the likelihood of multiple definitions of similar descriptors, minimize typographical errors associated with descriptor, enable sharing of predefined descriptors between work groups, enable efficient updates to descriptors across the entire system specification by modifying the base descriptor object, and provide various other advantages. In other words, using the present invention, the system specification creation process is simplified and accelerated while providing increased quality.

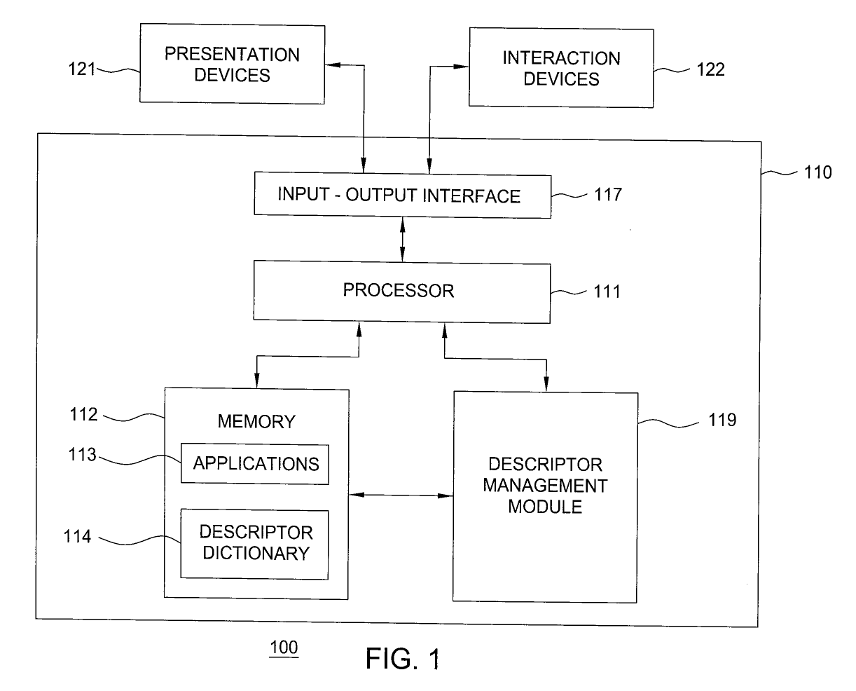

The descriptor management tool includes a descriptor dictionary. The descriptor dictionary defines descriptors. The descriptor dictionary includes descriptor entries, where each descriptor entry includes associated descriptor values which define that descriptor. The descriptor entries of the descriptor dictionary can be defined, searched, retrieved, displayed, browsed, and selected, and, ultimately, the associated descriptor (and, optionally, one or more descriptor values of that descriptor entry) may be inserted into a system specification represented as a specification worksheet (e.g., using word processing applications, graphical user interface information entry screens, and the like). The descriptor management tool may be implemented using any computer, such as the general-purpose computer depicted and described in FIG. 1.

FIG. 1 depicts a high-level block diagram of a general-purpose computer adapted to support descriptor management functions of the present invention. Specifically, general-purpose computer 100 includes a computer 110, presentation devices 121, and interaction devices 122. The computer 110 includes a processor 111, a memory 112, an input-output interface 117, and a descriptor management module 119. The processor 111 is coupled to each of memory 112, input-output interface 117, and descriptor management module 119. The descriptor management module 119 may also be directly coupled to memory 112. The input-output interface 117 is coupled to presentation devices 121 and interaction devices 122.

The processor 111 may include a central processing unit (CPU) or other similar control processors or control logic adapted for controlling computer 110 and associated peripherals such as presentation devices 121 and interaction devices 122. The memory 112 may include random access memory (RAM), read-only memory (ROM), and the like, as well as various combinations thereof. The memory 112 stores applications 113 (e.g., a word processing application, a graphical user interface application, and the like). The memory 112 stores a descriptor dictionary 114. The memory 112 may store any other information adapted for providing the descriptor management functions of the present invention.

The input-output interface 117 operates as an interface between computer 110 and associated computer peripherals, such as presentation devices 121 and interaction devices 122. The input-output interface 117 may include one or more ports providing output signals from computer 110 and/or accepting input signals to computer 110. The input-output interface 117 provides output signals to presentation devices 121 (e.g., a monitor, one or more speakers, and the like, as well as various combinations thereof). The input-output interface 117 receives input signals from interaction devices 122 (e.g., a mouse, a keyboard, a microphone, and the like, as well various combinations thereof).

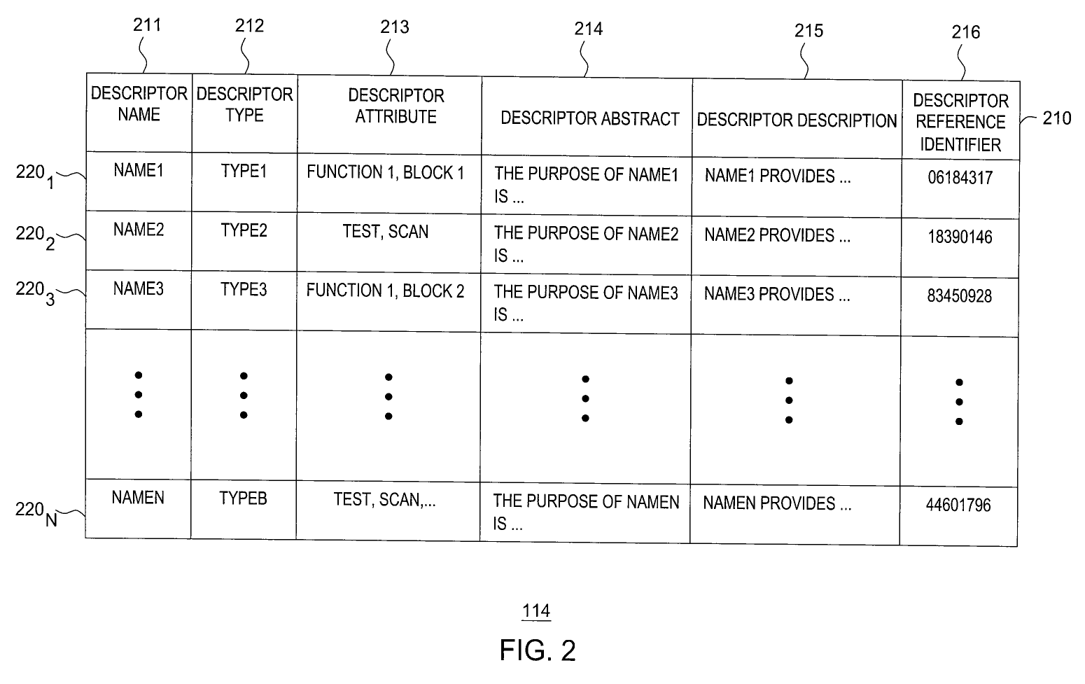

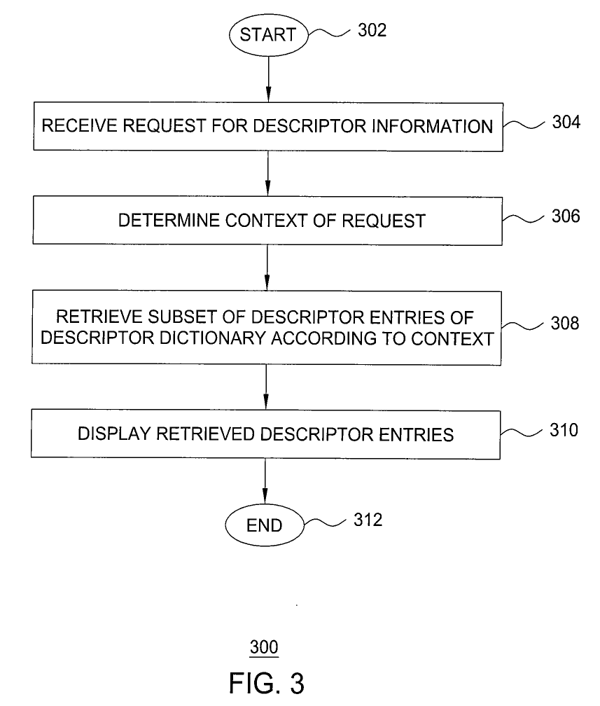

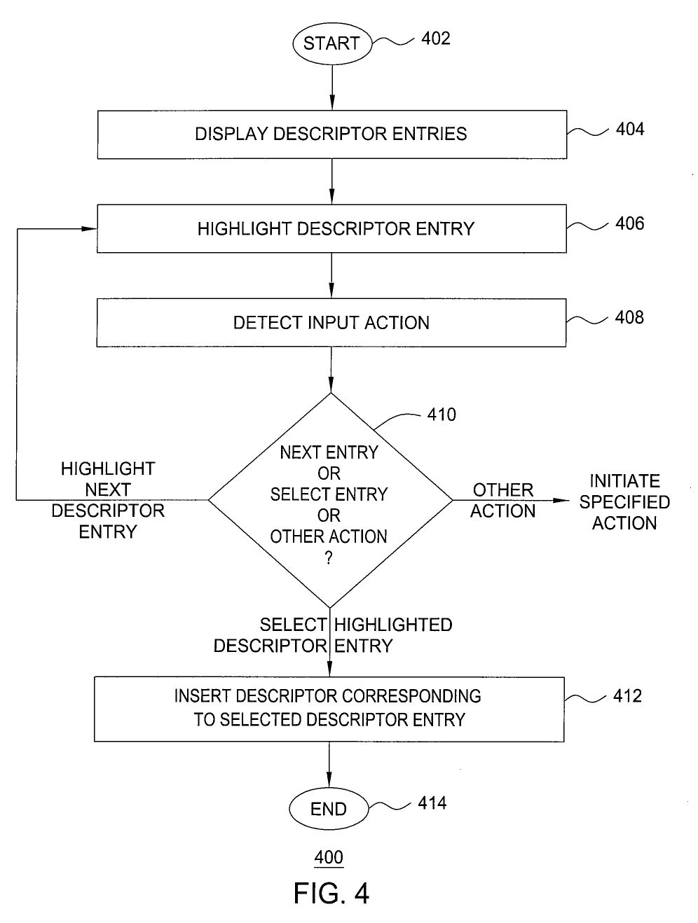

The descriptor management module 119 cooperates with processor 111, memory 112, input-output interface 117, and presentation devices 121 and interaction devices 122 to provide descriptor management functions of the present invention, such as defining new descriptors, searching and retrieving existing descriptors, browsing and selecting retrieved descriptors, and inserting selected descriptors into a system specification represented using a specification worksheet (e.g., using word processing applications, graphical user interface information entry screens, and the like). The descriptor management module 119 uses descriptor dictionary 114 depicted and described with respect to FIG. 2. The descriptor management module 119 performs methods 300 and 400 depicted and described with respect to FIG. 3 and FIG. 4, respectively.

FIG. 2 depicts a descriptor dictionary according to one embodiment of the present invention (illustratively, descriptor dictionary 114 as depicted and described with respect to FIG. 1). The descriptor dictionary 114 defines descriptors. The descriptor dictionary 114 defines descriptor using descriptor dictionary fields (which, as depicted in FIG. 2, comprise columns within descriptor dictionary 114). The descriptor dictionary 114 includes a plurality of descriptor dictionary fields including a descriptor name field 211, a descriptor type field 212, a descriptor attribute field 213, a descriptor abstract field 214, a descriptor description field 215, and a descriptor reference identifier field 216 (each of which is specified within descriptor dictionary 114 using a descriptor dictionary header row 210).

The descriptor name field 211 specifies the name of the descriptor (i.e., the descriptor). The name of the descriptor includes the character positions of the descriptor and the associated values of the respective character positions of the descriptor. The descriptor type field 212 specifies the type of the descriptor (or, potentially, multiple types of the descriptor if the descriptor falls under multiple descriptor types). The type of the descriptor may depend on the type of component the descriptor is intended to represent (e.g., hardware component versus software component). The descriptor attribute field 213 specifies one or more attributes of the descriptor. The attribute(s) of the descriptor may depend on the type of the descriptor. For example, the descriptor attributes of a descriptor may specify that the descriptor is associated with a specific function, logic block, and the like, as well as various combinations thereof.

The descriptor abstract field 214 includes a brief statement describing the descriptor (e.g., a brief statement of the purpose of the descriptor, when, where, how, and/or why the descriptor should be used, and the like, as well as various combinations thereof). The descriptor description field 215 includes a detailed description of the descriptor. The detailed description may include any information associated with the descriptor (e.g., a detailed description of the purpose of the descriptor, a detailed description of when, where, how, and/or why to use the descriptor, a detailed description about each of the individual character positions of the descriptor, and like information, as well as various combinations thereof).

The descriptor reference identifier field 216 includes a unique identifier assigned to the descriptor entry. In one embodiment, a descriptor reference identifier may be inserted into a worksheet along with the associated descriptor name. The descriptor reference identifier may be inserted into the worksheet as visible text or as invisible text (i.e., the descriptor reference identifier is associated with the descriptor object inserted into the worksheet). The descriptor reference identifier may be used to effect global changes within a worksheet specification. For example, rather than changing each individual instance of a descriptor within a worksheet specification, the descriptor entry in the descriptor dictionary may be changed, and the change is propagated to each individual instance of that descriptor within the worksheet specification using the descriptor reference identifier assigned to that descriptor entry.

As described herein, descriptor dictionary 114 includes a descriptor entry for each descriptor. As depicted in FIG. 2, descriptor dictionary 114 includes a plurality of descriptor entries 220₁-220_{N} (collectively, descriptor entries 220), where each descriptor entry 220 defines a descriptor using descriptor entry values specified for each of the descriptor dictionary fields for that descriptor entry 220. Specifically, each descriptor entry 220 includes a descriptor entry value for each of the descriptor name field 211, the descriptor type field 212, the descriptor attribute field 213, the descriptor abstract field 214, the descriptor description field 215, and the descriptor reference identifier field 216.

As depicted in FIG. 2, descriptor entry 220₁ includes a descriptor entry value of NAME1 in descriptor name field 211, a descriptor entry value of TYPE1 in descriptor type field 212, and descriptor entry values of FUNCTION1, BLOCK1 in descriptor attribute field 213. For descriptor entry 220₁, descriptor entry values of descriptor abstract field 214 and descriptor description field 215 indicate that “The purpose of NAME1 is . . . ” and that “NAME1 provides . . . ”, respectively. For descriptor entry 220₁, the descriptor entry value of descriptor reference identifier field 216 is 06184317. Although details are omitted, each of the other descriptor entries 220₂-220_{N} is defined using descriptor entry values included in respective descriptor dictionary fields.

FIG. 3 depicts a method according to one embodiment of the present invention. Specifically, method 300 of FIG. 3 includes a method for retrieving a subset of descriptor entries of a descriptor dictionary in response to a request for descriptor information maintained in the descriptor dictionary, and presenting the subset of descriptor entries in a manner enabling browsing and selection of the retrieved descriptor s entries. Although depicted and described as being performed serially, at least a portion of the steps of method 300 of FIG. 3 may be performed contemporaneously, or in a different order than depicted and described herein with respect to FIG. 3. The method 300 begins at step 302 and proceeds to step 304.

At step 304, a request for descriptor information is received. The request for descriptor information is initiated from a worksheet in which a system specification is created and modified. In one embodiment, the request for descriptor information is initiated manually by a user. For example, a user may select a menu item from a drop-down menu, click one or more buttons, or initiate any other action which may trigger a request for descriptor information. In one embodiment, the request for descriptor information is initiated automatically by a program. For example, as a user types a system specification in a worksheet, the worksheet program (or some other program) may detect that descriptor information may be required and, in response, may initiate a request for descriptor information. For example, a user may begin typing characters which the program interprets as being part of a descriptor and, in response, may initiate a request for descriptor information.

At step 306, a context of the request is determined. In one embodiment, the context of the request is determined using information provided with the request. In one embodiment, the context of the request is determined using information associated with the request (e.g., information from other modules, applications, device, and the like operating in conjunction with a descriptor management module to provide descriptor management functions of the present invention). The context of the request defines various parameters associated with the request, such as the source of the request, the type of the request, the search criteria on which the request is based, and the like, as well as various combinations thereof.

The context of the request for descriptor information may specify any information associated with the request for descriptor information. The context may specify the source of the request. The context may specify the type of request. The request may specify one or more descriptor dictionary fields of the descriptor dictionary. The context may specify the search criteria on which the request is based (e.g., specifying search criteria used to search the specified descriptor dictionary field(s) of the descriptor dictionary). The context of the request for descriptor information may include any other information which may be used in order to retrieve descriptor entries of the descriptor dictionary for display, browsing, selection, and, ultimately, insertion of associated descriptor names within a specification worksheet.

The context of the request may specify the source of the request. In one embodiment, the context of the request may specify whether the request was initiated from a worksheet (e.g., automatically as a user begins typing characters which the program interprets as being part of a descriptor), initiated from a worksheet application (e.g., using one or more menu items, toolbars, buttons, and/or other features available from a worksheet application, such as a word processing application, a graphical user interface application, and the like), and the like, as well as various combinations thereof.

In one embodiment, the request may be a descriptor name completion request. For example, a user may begin typing characters of a descriptor and a request for descriptor information may be initiated based on the characters entered by the user. For example, a user may type “XZ” in a system specification displayed in a specification worksheet, in which case the request for descriptor information is a request to retrieve all descriptor entries from the descriptor database for which the first two characters of the descriptor name field is “XZ”. In another example, a user may type “X<space><space>Z” in a worksheet and initiate a descriptor name completion request, in which case the request for descriptor information is a request to retrieve all descriptor entries from the descriptor dictionary for which the first and fourth characters of the descriptor name field are “X” and “Z”, respectively.

In one embodiment, the request may be a generic descriptor information request. For example, a user may specify one or more descriptor dictionary fields to be searched, and one or more search criteria for each of the selected descriptor dictionary fields. For example, a user may initiate a generic descriptor information request for all descriptor entries of the descriptor dictionary that have a descriptor type field value equal to “TYPE 3” and a descriptor attribute field value equal to “FUNCTION 2”. In another example, a user may initiate a generic descriptor information request for all descriptor entries of the descriptor dictionary that have descriptor attribute field values of both “VAR 2” and “FUNCTION 2”.

In one embodiment, the type of request may be a combination of such requests described herein (e.g., a combination of a descriptor name completion request and a generic descriptor information request). For example, a descriptor name completion request may be further narrowed by providing the user with an option to specify search criteria to be searched in one or more other descriptor dictionary fields of the descriptor dictionary. In continuation of examples described hereinabove, where a user types “XZ” in a worksheet to request all descriptor entries from the descriptor database for which the first two characters of the descriptor name field is “XZ”, the user may further narrow the request to a request for a subset of those descriptor entries having a descriptor name beginning with “XY” that also have a descriptor type field value equal to “TYPE 3”.

At step 308, a subset of the descriptor entries of the descriptor dictionary is retrieved. The descriptor entries are retrieved according to the context of the request for descriptor information. The descriptor entries of the descriptor dictionary are searched according to the context of the request for descriptor information. The descriptor entries of the descriptor dictionary are searched according to search criteria which specify one or more descriptor dictionary fields to be searched and one or more descriptor dictionary field values to be matched for each of those descriptor dictionary fields. The search criteria by which descriptor entries of the descriptor dictionary are searched is determined from the context of the request for descriptor information.

At step 310, the retrieved descriptor entries are displayed. The retrieved descriptor entries are displayed by generating a presentation data stream and inserting into the presentation data stream imagery associated with the retrieved descriptor entries to enable selection of one or more of the descriptor entries for insertion of the corresponding descriptor(s) within a worksheet. The presentation data stream including the inserted imagery associated with the retrieved descriptor entries is provided to a display device (illustratively, presentation devices 121 depicted and described with respect to FIG. 1). The display device receives and processes the presentation data stream including the inserted imagery associated with the retrieved descriptor entries in order to display the imagery representative of the retrieved descriptor entries. At step 312, method 300 ends.

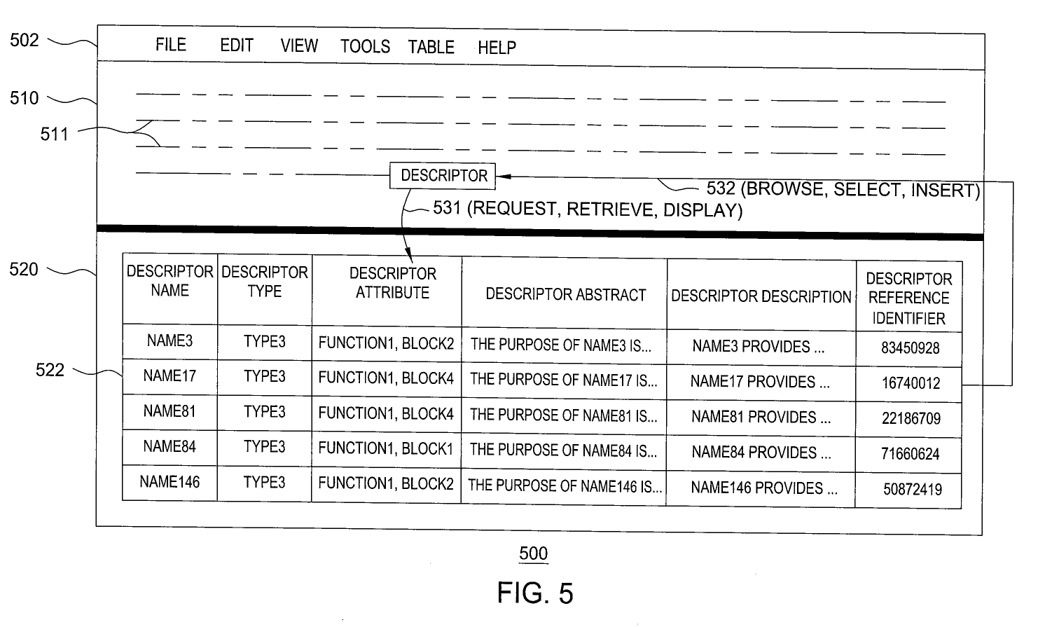

In one embodiment, retrieved descriptor entries are displayed in an application (e.g., a word processing application, a graphical user interface application, and the like). In one embodiment, retrieved descriptor entries are displayed in an application separate from the system specification application from which the request for descriptor information was initiated. In one embodiment, retrieved descriptor entries are displayed within the system specification application from which the request for descriptor information was initiated. The retrieved descriptor entries may be highlighted, browsed, and selected, as depicted and described with respect to FIG. 4. An exemplary system specification application displaying an exemplary worksheet and associated descriptor dictionary entries is depicted and described with respect to FIG. 5.

FIG. 4 depicts a method according to one embodiment of the present invention. Specifically, method 300 of FIG. 4 includes a method for browsing retrieved and displayed descriptor entries, selecting retrieved and displayed descriptor entries, and inserting descriptors corresponding to selected descriptor entries within a system specification displayed within a specification worksheet. Although primarily depicted and described as being performed serially, at least a portion of the steps of method 400 of FIG. 4 may be performed contemporaneously, or in a different order than depicted and described with respect to FIG. 4. The method 400 begins at step 402 and proceeds to step 404.

At step 404, descriptor entries are displayed. The descriptor entries are displayed using a display device (illustratively, presentation devices 121 of FIG. 1). The displayed descriptor entries are a subset of descriptor entries retrieved from a descriptor dictionary according to a context of a request for descriptor information. The descriptor entries may be retrieved and displayed as depicted and described herein with respect to FIG. 3. At step 406, one of the displayed descriptor entries is highlighted. In one embodiment, the first descriptor entry in the subset of retrieved descriptor entries is highlighted. In one embodiment, one of the descriptor entries most closely matching search criteria specified by the context of the request for descriptor information is highlighted.

At step 408, an input action is detected. The input action is initiated by a user using one or more interaction devices (illustratively, interaction devices 122 of FIG. 1). If the user wishes to continue browsing displayed descriptor entries, the user may initiate an browse action adapted to highlight a descriptor entry. For example, the user may highlight a descriptor entry using a hotkey on a keyboard, an arrow key on a keyboard, a mouse click (e.g., single click), and the like, as well as various combinations thereof. If the user wishes to insert a descriptor associated with a currently highlighted descriptor entry into the system specification displayed in the specification worksheet, the user may initiate an select action adapted to select the highlighted descriptor entry. For example, the user may select a highlighted descriptor entry using a hotkey on a keyboard, an ENTER key on a keyboard, a mouse click (e.g., double click), and the like, as well as various combinations thereof.

At step 410, a determination is made as to the type of input action detected (i.e., a determination as to whether the detected input action is a request to highlight a displayed descriptor entry, a request to select a highlighted descriptor entry, or another type of request). If the type of input action is a request to highlight a displayed descriptor entry, method 400 returns to step 404, at which point the displayed descriptor entry specified by the input action is highlighted. If the type of input action is a request to select a highlighted descriptor entry, method 400 proceeds to step 412.

At step 412, the descriptor corresponding to the selected descriptor entry is inserted within the specification worksheet of the system specification application. The descriptor name for the selected descriptor (i.e., the value from the descriptor name field of the descriptor dictionary for the selected descriptor entry) may be inserted within the specification worksheet of the system specification application. In one embodiment, values from one or more other descriptor dictionary fields may be inserted within the specification worksheet of the system specification application. For example, values from descriptor dictionary fields such as the descriptor type field, descriptor attribute field, and the like, may be inserted within the specification worksheet of the system specification application for the selected descriptor entry.

In one embodiment, the descriptor reference identifier for the selected descriptor (i.e., the value from the descriptor reference identifier field of the descriptor dictionary for the selected descriptor entry) is inserted within the specification worksheet of the system specification application. As described herein, the descriptor reference identifier may be used to propagate changes (e.g., changes to one or more values of one or more descriptor dictionary fields for a particular descriptor dictionary entry) to each of the instances of the corresponding descriptor within the specification worksheet. In one such embodiment, the descriptor reference identifier may be inserted as visible text or invisible text. At step 414, method 400 ends.

Although omitted for purposes of clarity, if the type of input action is another type of request (i.e., other than browsing or selecting displayed descriptor entries), method 400 proceeds to perform the specified action. For example, other types of requests may include a request to create a new descriptor (i.e., create a new descriptor entry in the descriptor dictionary), a request to retrieve a different subset of descriptor entries from the descriptor dictionary (e.g., narrow or expand the existing subset of descriptor entries or perform a different search of the descriptor dictionary altogether), or any other type of request associated with the descriptor management functions of the present invention.

FIG. 5 depicts an exemplary graphical user interface displaying a system specification application according to one embodiment of the present invention. The system specification application 500 displays a specification worksheet and descriptor entries retrieved from a descriptor dictionary. As described herein, system specification application 500 may include a word processing application (e.g., Microsoft WORD, Adobe FRAMEMAKER, and the like), a graphical user interface information entry screen (e.g., for a GUI-based system specification application), and the like. The system specification application 500 includes a menu region 502, a specification display region 510, and a descriptor display region 520.

The menu region 510 includes menu buttons, including FILE, EDIT, VIEW, TOOLS, TABLE, and HELP menu buttons. The selection of each menu button results in a drop-down menu including additional menu options and sub-menu options. The menu buttons available from menu region 510 may include menu options adapted for providing various descriptor management functions of the present invention (e.g., requesting descriptor information from a descriptor dictionary, browsing retrieved descriptor entries, and like functions, as well as various combinations thereof). Although depicted and described with respect to specific menu buttons, menu region 510 may include various other combinations of menu buttons.

The specification display region 510 displays a system specification (denoted as system specification 511). As described herein, as a user enters system specification 511, the user (or, optionally, the system) determines that a descriptor is required and initiates a request to retrieve descriptor information from a descriptor dictionary. For a request to retrieve descriptor information that is initiated by a user, the user may initiate the request to retrieve descriptor information from one or more of menu region 502 (e.g., selecting a menu option available from one of the menu buttons, selecting an option from a toolbar, and the like), specification display region 510 (e.g., typing a portion of a descriptor name, using a right-click operation and selecting an option, and the like), or descriptor display region 520.

The descriptor display region 520 displays descriptor entries (denoted as descriptor entries 521). The descriptor entries 521 comprise a subset of the descriptor entries of the descriptor dictionary (i.e., descriptor entries retrieved in response to a request for descriptor information, which may be initiated from menu region 502, specification display region 510, or descriptor display region 520). In one embodiment, at least a portion of each descriptor entry displayed in descriptor display region 520 may be made selectable (e.g., using hyperlinks (e.g., such as displaying descriptor names as hyperlinks), using buttons, and the like), thereby simplifying selection of a descriptor entry for insertion of the associated descriptor within system specification 511 displayed in specification display region 510.

In one embodiment, descriptor display region 520 displays retrieved descriptor entries in a table format. In one such embodiment, descriptor display region 520 displays retrieved descriptor entries in a table format identical to, or at least similar to, the format of the descriptor dictionary from which the descriptor entries were retrieved. In one embodiment, in which descriptor display region 520 displays the retrieved descriptor entries in a table format, the table may be configurable. For example, a table displaying descriptor entries in descriptor display region 520 may be configurable in a manner such that columns can be resized, columns can be moved, rows can be resized, rows can be moved, and the like, as well as various combinations thereof).

As depicted in FIG. 5, a request for descriptor information is initiated, a subset of the descriptor entries of a descriptor dictionary is retrieved from the descriptor dictionary, and the retrieved descriptor entries are displayed in descriptor display region 520. These functions are denoted as operation 531. The functions associated with operation 531 may be better understood with respect to FIG. 3. As depicted in FIG. 5, descriptor entries displayed in descriptor display region 520 are browsed, one of the descriptor entries displayed in descriptor display region 520 is selected, and the selected one of the descriptor entries is inserted within system specification 511 displayed in specification display region 510. These functions are denoted as operation 532. The functions associated with operation 532 may be better understood with respect to FIG. 4.

Although primarily depicted and described with respect to three regions, system specification application 500 may include fewer or more regions. Although depicted using a specific layout, system specification application 500 (illustratively, specification display region 510 and descriptor display region 520) may be configured using a different layout. For example, in other embodiments the descriptor display region 520 may be positioned to the left of, above, or to the right of specification display region 510. Although depicted as being displayed within a specific region of system specification application 500 (illustratively, descriptor display region 520), descriptor entries 521 may be displayed in other locations (e.g., in other regions of system specification application 500, in a separate window associated with system specification application 500, and the like).

Although depicted and described with respect to a user interaction model in which descriptor management functions of the present invention are provided using a computer having a monitor, keyboard, and mouse, the descriptor management functions of the present invention may be provided using other devices or combinations of devices, such as televisions and associated interaction devices (e.g., set top box, remote control, and the like), portable user devices, and the like, as well as various combinations thereof. Although depicted and described with respect to a user interaction model in which descriptor management functions of the present invention are provided using a graphical user interface, the descriptor management functions of the present invention may be provided using various other user interaction models, such as text-based user interaction models, zooming user interface (ZUI)-based user interaction models, and the like, as well as various combinations thereof.

Although primarily depicted and described herein with respect to a descriptor dictionary having specific descriptor dictionary fields, descriptor dictionaries in accordance with other embodiments of the present invention may include fewer or more descriptor dictionary fields. Although primarily depicted and described herein with respect to embodiments in which a subset of descriptor entries of the descriptor dictionary is retrieved and displayed, in other embodiments the entire descriptor dictionary may be retrieved and displayed, thereby enabling a user to browse all possible descriptor entries of the descriptor dictionary (e.g., if the user is unsure as to whether the desired descriptor exists in the descriptor dictionary).

Although primarily depicted and described herein with respect to managing textual descriptors such as textual mnemonics, acronyms, identifiers, and the like, in various other embodiments the present invention may be used to manage graphical objects. In one embodiment, for example, the present invention may be used to manage figures in a document. For example, a descriptor may be defined with respect to whether or not the descriptor is visible in one or more figures and, if the descriptor is visible in one or more figures, the descriptor may be further defined by identification of the one or more figures in which the descriptor is visible, indication of the location of the descriptor within each of the one or more figures, and the like, as well as various combinations thereof. In one such embodiment, the descriptor dictionary may include one or more additional descriptor dictionary fields to define such additional parameters associated with such descriptors.

Although primarily depicted and described herein with respect to supporting descriptor management functions in system specification applications, the present invention may support descriptor management functions in various other applications. Although primarily depicted and described herein with respect to system specifications including requirements documents, system design documents, and the like, the present invention may provide management functions for descriptors for various other types of documents. For example, the present invention may provide descriptor management functions for technical journal papers, patent applications, and any other type of document which may use descriptors such as mnemonics, acronyms, identifiers, and the like.

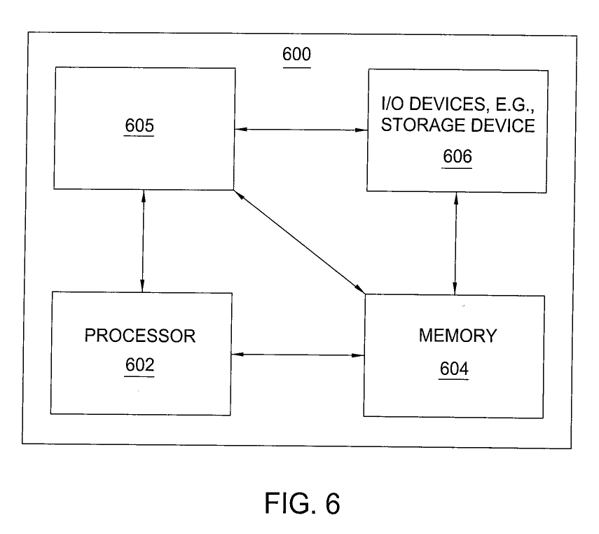

FIG. 6 depicts a high-level block diagram of a general-purpose computer suitable for use in performing the functions described herein. As depicted in FIG. 6, system 600 includes a processor element 602 (e.g., a central processing unit (CPU)), a memory 604, e.g., random access memory (RAM) and/or read only memory (ROM), a descriptor management module 605, and various input/output devices 606 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present descriptor management process 605 can be loaded into memory 604 and executed by processor 602 to implement the functions as discussed hereinabove. As such, descriptor management process 605 (including associated data structures) of the present invention can be stored on a computer readable medium or carrier, e.g., RAM memory, magnetic or optical drive or diskette and the like.

It is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast or other signal bearing medium, and/or stored within a working memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method, comprising:
receiving a request for descriptor information maintained in a descriptor dictionary comprising a plurality of descriptor entries defining a respective plurality of descriptors;
determining a context associated with the request for descriptor information;
retrieving, according to the determined context, a subset of the descriptor entries of the descriptor dictionary; and
inserting into a presentation data stream imagery associated with the subset of descriptor entries to enable selection of one or more of the descriptor entries for insertion of the corresponding descriptor within a worksheet.

2. The method of claim 1, wherein the context comprises a request for a descriptor name completion.

3. The method of claim 1, wherein the context comprises a request for a descriptor search, wherein the request for the descriptor search includes at least one search criterion.

4. The method of claim 1, further comprising:
displaying the subset of descriptor entries by processing the presentation data stream to extract the imagery associated with the subset of descriptor entries.

5. The method of claim 4, further comprising:
highlighting one of the displayed descriptor entries in response to a browse action.

6. The method of claim 4, further comprising:
selecting one of the displayed descriptor entries in response to a select action; and
inserting a descriptor name of the selected descriptor entry within the worksheet.

7. The method of claim 4, further comprising:
highlighting one of the displayed descriptor entries in response to a browse action;
receiving a request to modify the highlighted descriptor entry; and
displaying a descriptor modification screen in response to the request to modify the highlighted descriptor entry.

8. The method of claim 7, further comprising:
modifying one of the descriptor entries, wherein modifying the one of the descriptor entries comprises modifying a value of one of a plurality of descriptor dictionary fields associated with the one of the descriptor entries;
storing the modified one of the descriptor entries in the descriptor dictionary; and
propagating, using a reference identifier associated with the modified one of the descriptor entries, the modified value of the modified descriptor entry to at least one other point of insertion of the descriptor within the worksheet.

9. An apparatus, comprising:
means for receiving a request for descriptor information maintained in a descriptor dictionary comprising a plurality of descriptor entries defining a respective plurality of descriptors;
means for determining a context associated with the request for descriptor information;
means for retrieving, according to the determined context, a subset of the descriptor entries of the descriptor dictionary; and
means for inserting into a presentation data stream imagery associated with the subset of descriptor entries to enable selection of one or more of the descriptor entries for insertion of the corresponding descriptor within a worksheet.

10. The apparatus of claim 9, wherein the context comprises a request for a descriptor name completion.

11. The apparatus of claim 9, wherein the context comprises a request for a descriptor search, wherein the request for the descriptor search includes at least one search criterion.

12. The apparatus of claim 9, further comprising:
means for displaying the subset of descriptor entries by processing the presentation data stream to extract the imagery associated with the subset of descriptor entries.

13. The apparatus of claim 12, further comprising:
means for highlighting one of the displayed descriptor entries in response to a browse action.

14. The apparatus of claim 12, further comprising:
means for selecting one of the displayed descriptor entries in response to a select action; and
means for inserting a descriptor name of the selected descriptor entry within the worksheet.

15. The apparatus of claim 12, further comprising:
means for highlighting one of the displayed descriptor entries in response to a browse action;
means for receiving a request to modify the highlighted descriptor entry; and
means for displaying a descriptor modification screen in response to the request to modify the highlighted descriptor entry.

16. The apparatus of claim 15, further comprising:
means for modifying one of the descriptor entries, wherein modifying the one of the descriptor entries comprises modifying a value of one of a plurality of descriptor dictionary fields associated with the one of the descriptor entries;
means for storing the modified one of the descriptor entries in the descriptor dictionary; and
means for propagating, using a reference identifier associated with the modified one of the descriptor entries, the modified value of the modified descriptor entry to at least one other point of insertion of the descriptor within the worksheet.

17. A computer readable medium storing a software program, that, when executed by a computer, causes the computer to perform a method comprising:
receiving a request for descriptor information maintained in a descriptor dictionary comprising a plurality of descriptor entries defining a respective plurality of descriptors;
determining a context associated with the request for descriptor information;
retrieving, according to the determined context, a subset of the descriptor entries of the descriptor dictionary; and
inserting into a presentation data stream imagery associated with the subset of descriptor entries to enable selection of one or more of the descriptor entries for insertion of the corresponding descriptor within a worksheet.

18. The computer readable medium of claim 17, wherein the context comprises at least one of a request for a descriptor name completion and a request for a descriptor search, wherein the request for the descriptor search includes at least one search criterion.

19. The computer readable medium of claim 17, further comprising:
displaying the subset of descriptor entries by processing the presentation data stream to extract the imagery associated with the subset of descriptor entries;
highlighting one of the displayed descriptor entries in response to a browse action;
selecting one of the displayed descriptor entries in response to a select action; and
inserting a descriptor name of the selected descriptor entry within the worksheet.

20. The computer readable medium of claim 17, further comprising:
modifying one of the descriptor entries, wherein modifying the one of the descriptor entries comprises modifying at least one value of a plurality of values of the one of the descriptor entries;
storing the modified one of the descriptor entries in the descriptor dictionary; and
propagating at least one of the plurality of values of the modified descriptor entry to at least one other point of insertion of the descriptor within the worksheet using a reference identifier associated with the modified one of the descriptor entries.
